(19) United States
(12) Patent Application Publication
(10) Pub. No.: US 2025/0141797 A1
(43) Pub. Date: May 1, 2025

(54) TRANSPORT OF EXTENDED PERSONAL AREA NETWORK (XPAN) CONTROL FRAMES ACROSS NETWORKS

(71) Applicant: QUALCOMM Incorporated, San Diego, CA (US)

(72) Inventors: Debashis DUTT, San Jose, CA (US); Ahmed Ragab ELSHERIF, San Jose, CA (US); Sriman MIRYALA, Hyderabad (IN)

(21) Appl. No.: 18/499,999

(22) Filed: Nov. 1, 2023

(51) Int. Cl. H04L 45/74; H04W 28/06

(52) U.S. Cl. CPC H04L 45/74; H04W 28/065

(57) ABSTRACT

This disclosure provides methods, components, devices and systems for transport of extended personal area network (XPAN) control frames across networks. Some aspects more specifically relate to the transmission of a message within an XPAN, in which a first wireless station (STA) and a second STA are out of range (such as greater than 10 meters apart). For example, the first STA and the second STA may share a Layer 2 (L2) network, a Layer 3 (L3) network, neither, or both. The first STA may generate the message, which may include an XPAN control frame and at least one network communication header. In some implementations, the at least one network communication header may include an L3 header and an L2 header. The first STA may transmit the message to the second STA via one or more access points (APs).

### TECHNICAL FIELD

This disclosure relates to wireless communication and, more specifically, to transport of extended personal area network (XPAN) control frames across networks. Various aspects relate generally to the transmission of a message within an XPAN, in which two endpoint devices (such as a first wireless station (STA) and a second STA) are out of range (such as, for example, greater than 10 meters apart).

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, a first STA may generate a message for transmission to a second STA. The first STA and the second STA may share a same Layer 2 (L2) network, a same Layer 3 (L3) network, neither, or both.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a first wireless station (STA). The method may include generating a message to be transmitted to a second wireless STA that is in a personal area network with the first wireless STA, the message including a personal area network control frame and at least one network communication header associated with a second network that is different from the personal area network and transmitting, to the second wireless STA, the message via the second network.

Another innovative aspect of the subject matter described in this disclosure can be implemented in a first wireless STA for wireless communications. The first wireless STA may include a processing system that includes processor circuitry and memory circuitry that stores code. The processing system may be configured to cause the first wireless STA to generate a message to be transmitted to a second wireless STA that is in a personal area network with the first wireless STA, the message including a personal area network control frame and at least one network communication header associated with a second network that is different from the personal area network and transmit, to the second wireless STA, the message via the second network.

Another innovative aspect of the subject matter described in this disclosure can be implemented in another first wireless STA for wireless communications. The first wireless STA may include means for generating a message to be transmitted to a second wireless STA that is in a personal area network with the first wireless STA, the message including a personal area network control frame and at least one network communication header associated with a second network that is different from the personal area network and means for transmitting, to the second wireless STA, the message via the second network.

Another innovative aspect of the subject matter described in this disclosure can be implemented in a non-transitory computer-readable medium storing code for wireless communications. The code may include instructions executable by a processor to generate a message to be transmitted to a second wireless STA that is in a personal area network with the first wireless STA, the message including a personal area network control frame and at least one network communication header associated with a second network that is different from the personal area network and transmit, to the second wireless STA, the message via the second network.

In some examples of the method, first wireless STAs, and non-transitory computer-readable medium described herein, generating the message may include operations, features, means, or instructions for generating the personal area network control frame at a personal area network application, a personal area network kernel module, or a raw socket at the first wireless STA.

In some examples of the method, first wireless STAs, and non-transitory computer-readable medium described herein, generating the message may include operations, features, means, or instructions for generating a Layer 3 (L3) header as at least a part of the at least one network communication header, where the L3 header pertains to network layer communications, and where a combination of the personal area network control frame and the L3 header may be an Internet Protocol (IP) encapsulated control frame.

In some examples of the method, first wireless STAs, and non-transitory computer-readable medium described herein, the L3 header may be an IP Version 4 (IPv4) header.

In some examples of the method, first wireless STAs, and non-transitory computer-readable medium described herein, the IPv4 header includes a protocol field which may be indicative that the message includes the personal area network control frame.

In some examples of the method, first wireless STAs, and non-transitory computer-readable medium described herein, the L3 header may be an IP Version 6 (IPv6) header.

In some examples of the method, first wireless STAs, and non-transitory computer-readable medium described herein, the IPV6 header includes a next header field which may be indicative that the message includes the personal area network control frame.

In some examples of the method, first wireless STAs, and non-transitory computer-readable medium described herein, generating the message may include operations, features, means, or instructions for generating a Layer 2 (L2) header as at least a part of the at least one network communication header, where the L2 header pertains to data link layer communications, and may be in addition to the IP encapsulated control frame.

In some examples of the method, first wireless STAs, and non-transitory computer-readable medium described herein, the L2 header includes a field indicating an Ethernet type and the Ethernet type may be one of IPV4 or IPv6.

In some examples of the method, first wireless STAs, and non-transitory computer-readable medium described herein, transmitting the message via the second network may include operations, features, means, or instructions for transmitting the message via a same basic service set (BSS) or an extended service set (ESS) in an L2-bridged network in accordance with the L2 header, where the second network may be the L2-bridged network.

In some examples of the method, first wireless STAs, and non-transitory computer-readable medium described herein, transmitting the message via the second network may include operations, features, means, or instructions for transmitting the message via an L3 network in accordance with the L3 header, where the second network may be the L3 network.

Some examples of the method, first wireless STAs, and non-transitory computer-readable medium described herein may further include operations, features, means, or instructions for identifying a trigger to participate in a personal area network communication with the second wireless STA, where generation of the message to be transmitted to the second wireless STA may be based on identifying the trigger.

In some examples of the method, first wireless STAs, and non-transitory computer-readable medium described herein, the trigger includes an identification that the message to be transmitted to the second wireless STA may be one of a predetermined type of message.

Some examples of the method, first wireless STAs, and non-transitory computer-readable medium described herein may further include operations, features, means, or instructions for receiving data to be forwarded to the second wireless STA, where receipt of the data may be the trigger.

In some examples of the method, first wireless STAs, and non-transitory computer-readable medium described herein, the personal area network may be an extended personal area network (XPAN).

In some examples of the method, first wireless STAs, and non-transitory computer-readable medium described herein, the personal area network control frame contains a type field, a length of a payload, and the payload.

A method for wireless communications by an access point is described. The method may include receiving a message from a first wireless STA that includes a personal area network control frame and at least one network communication header associated with a network including the access point and forwarding, to a second wireless STA, the message based on the message including the personal area network control frame, where the first wireless STA and the second wireless STA are within a personal area network associated with the personal area network control frame.

An access point for wireless communications is described. The access point may include a processing system that includes processor circuitry and memory circuitry that stores code. The processing system may be configured to cause the access point to receive a message from a first wireless STA that includes a personal area network control frame and at least one network communication header associated with a network including the access point and forwarding, to a second wireless STA, the message based at least in part on the message including the personal area network control frame, where the first wireless STA and the second wireless STA are within a personal area network associated with the personal area network control frame.

Another access point for wireless communications is described. The access point may include means for receiving a message from a first wireless STA that includes a personal area network control frame and at least one network communication header associated with a network including the access point and means for forwarding, to a second wireless STA, the message based on the message including the personal area network control frame, where the first wireless STA and the second wireless STA are within a personal area network associated with the personal area network control frame.

A non-transitory computer-readable medium storing code for wireless communications is described. The code may include instructions executable by a processor to receive a message from a first wireless STA that includes a personal area network control frame and at least one network communication header associated with a network including the access point and forwarding, to a second wireless STA, the message based at least in part on the message including the personal area network control frame, where the first wireless STA and the second wireless STA are within a personal area network associated with the personal area network control frame.

In some examples of the method, access points, and non-transitory computer-readable medium described herein, receiving the message may include operations, features, means, or instructions for receiving an L3 header as at least a part of the at least one network communication header, where the L3 header pertains to network layer communications, and where a combination of the personal area network control frame and the L3 header may be an IP encapsulated control frame.

In some examples of the method, access points, and non-transitory computer-readable medium described herein, the L3 header may be an IPv4 header.

In some examples of the method, access points, and non-transitory computer-readable medium described herein, the IPv4 header includes a protocol field which may be indicative that the message includes the personal area network control frame.

In some examples of the method, access points, and non-transitory computer-readable medium described herein, the L3 header may be an IPV6 header.

In some examples of the method, access points, and non-transitory computer-readable medium described herein, the IPv6 header includes a next header field which may be indicative that the message includes the personal area network control frame.

In some examples of the method, access points, and non-transitory computer-readable medium described herein, receiving the message may include operations, features, means, or instructions for receiving an L2 header as at least a part of the at least one network communication header, where the L2 header pertains to data link layer communications, and may be in addition to the IP encapsulated control frame.

In some examples of the method, access points, and non-transitory computer-readable medium described herein, the L2 header includes a field indicating an Ethernet type and the Ethernet type may be one of IPV4 or IPv6.

In some examples of the method, access points, and non-transitory computer-readable medium described herein, forwarding the message may include operations, features, means, or instructions for forwarding the message via a same BSS or an ESS in an L2-bridged network in accordance with the L2 header, where the network may be the L2-bridged network.

In some examples of the method, access points, and non-transitory computer-readable medium described herein, forwarding the message may include operations, features, means, or instructions for forwarding the message via an L3 network in accordance with the L3 header, where the network may be the L3 network.

In some examples of the method, access points, and non-transitory computer-readable medium described herein, the personal area network may be an XPAN.

In some examples of the method, access points, and non-transitory computer-readable medium described herein, the personal area network control frame contains a type field, a length of a payload, and the payload.

A method for wireless communications by a first wireless STA is described. The method may include receiving a message from a second wireless STA that is in a personal area network with the first wireless STA, where the message includes a personal area network control frame and at least one network communication header associated with a second network that is different from the personal area network, where the message is received via the second network and decoding the message based on the message including the personal area network control frame.

A first wireless STA for wireless communications is described. The first wireless STA may include a processing system that includes processor circuitry and memory circuitry that stores code. The processing system may be configured to cause the first wireless STA to receive a message from a second wireless STA that is in a personal area network with the first wireless STA, where the message includes a personal area network control frame and at least one network communication header associated with a second network that is different from the personal area network, where the message is received via the second network and decode the message based on the message including the personal area network control frame.

Another first wireless STA for wireless communications is described. The first wireless STA may include means for receiving a message from a second wireless STA that is in a personal area network with the first wireless STA, where the message includes a personal area network control frame and at least one network communication header associated with a second network that is different from the personal area network, where the message is received via the second network and means for decoding the message based on the message including the personal area network control frame.

A non-transitory computer-readable medium storing code for wireless communications is described. The code may include instructions executable by a processor to receive a message from a second wireless STA that is in a personal area network with the first wireless STA, where the message includes a personal area network control frame and at least one network communication header associated with a second network that is different from the personal area network, where the message is received via the second network and decode the message based on the message including the personal area network control frame.

In some examples of the method, first wireless STAs, and non-transitory computer-readable medium described herein, receiving the message may include operations, features, means, or instructions for receiving an L3 header as at least a part of the at least one network communication header, where the L3 header pertains to network layer communications, and where a combination of the personal area network control frame and the L3 header may be an IP encapsulated control frame.

In some examples of the method, first wireless STAs, and non-transitory computer-readable medium described herein, the L3 header may be an IPV4 header.

In some examples of the method, first wireless STAs, and non-transitory computer-readable medium described herein, the IPv4 header includes a protocol field which may be indicative that the message includes the personal area network control frame.

In some examples of the method, first wireless STAs, and non-transitory computer-readable medium described herein, receiving the message may include operations, features, means, or instructions for receiving an L2 header as at least a part of the at least one network communication header, where the L2 header pertains to data link layer communications, and may be in addition to the IP encapsulated control frame.

In some examples of the method, first wireless STAs, and non-transitory computer-readable medium described herein, the L2 header includes a field indicating an Ethernet type and the Ethernet type may be one of IPV4 or IPv6.

In some examples of the method, first wireless STAs, and non-transitory computer-readable medium described herein, receiving the message may include operations, features, means, or instructions for receiving the message via a same BSS or an ESS in an L2-bridged network in accordance with the L2 header, where the second network may be the L2-bridged network.

In some examples of the method, first wireless STAs, and non-transitory computer-readable medium described herein, receiving the message may include operations, features, means, or instructions for receiving the message via an L3 network in accordance with the L3 header, where the second network may be the L3 network.

In some examples of the method, first wireless STAs, and non-transitory computer-readable medium described herein, the L3 header may be an IPV6 header.

In some examples of the method, first wireless STAs, and non-transitory computer-readable medium described herein, the IPV6 header includes a next header field which may be indicative that the message includes the personal area network control frame.

In some examples of the method, first wireless STAs, and non-transitory computer-readable medium described herein, the personal area network may be an XPAN.

In some examples of the method, first wireless STAs, and non-transitory computer-readable medium described herein, the personal area network control frame contains a type field, a length of a payload, and the payload.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows a pictorial diagram of another example wireless communication network.

FIG. 6 shows a pictorial diagram of another example wireless communication network that supports transport of extended personal area network (XPAN) control frames across networks.

FIG. 7 shows a flowchart illustrating an example of a packetization process performable by a wireless STA that supports transport of XPAN control frames across networks.

FIG. 8 shows an example of packet format that supports transport of XPAN control frames across networks.

FIG. 9 shows an example of a process flow that supports transport of XPAN control frames across networks.

FIG. 10 shows a block diagram of an example wireless communication device that supports transport of XPAN control frames across networks.

FIG. 11 shows a block diagram of an example wireless communication device that supports transport of XPAN control frames across networks.

FIGS. 12-14 show flowcharts illustrating example processes performable by or at a first wireless station that supports transport of XPAN control frames across networks.

FIG. 15 shows a flowchart illustrating an example process performable by or at an AP that supports transport of XPAN control frames across networks.

FIG. 16 shows a flowchart illustrating an example process performable by or at a first wireless station that supports transport of XPAN control frames across networks.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an Internet of things (IOT) network.

Various aspects relate generally to wireless communications within a wireless personal area network. Some aspects more specifically relate to the transmission of a message within an extended personal area network (XPAN), in which two endpoint devices (such as a first wireless station (STA) and a second STA) are out of range (such as greater than 10 meters apart). Because the first STA and the second STA are out of range for direct communication with each other, the wireless communications between the first STA and the second STA may traverse other networks. For example, the first STA and the second STA may share a Layer 2 (L2) network, a Layer 3 (L3) network, neither, or both. In some implementations, the first STA may generate the message, which may include an XPAN control frame and at least one network communication header. In some implementations, the at least one network communication header may include an L3 header that may be either an Internet protocol version 4 (IPv4) header or an Internet protocol version 6 (IPv6) header and may include a field indicating that the message includes the XPAN control frame. In some implementations, the at least one network communication header may include an L2 header that may include a field indicating an Ethertype of either IPv4 or IPv6. The first STA may transmit the message to the second STA via one or more access points (APs).

Particular aspects of the subject matter described in this disclosure can be implemented to realize one or more of the following potential advantages. In some implementations, by encapsulating the XPAN control frame using one or more network communication headers, the described techniques can be used to efficiently transmit messages from a first STA to a second STA that are out of range for direct transmissions. Encapsulating the XPAN control frame using standard L2 and L3 headers may provide a scalable and expandable solution across standard network topologies—such as a large home or enterprise network—and deployable across a large class of network devices. One or more proprietary fields in the L3 header may allow for prioritization of XPAN control frames while reducing latency, CPU utilization, and power consumption by bypassing the Layer 4 (L4) networking stack, the generic attribute profile (GATT) protocol, and the Bluetooth (BT) host. Additionally, encapsulation may allow a device to deliver the XPAN control frames to a receiving endpoint independent of BT stack implementation at the receiving endpoint.

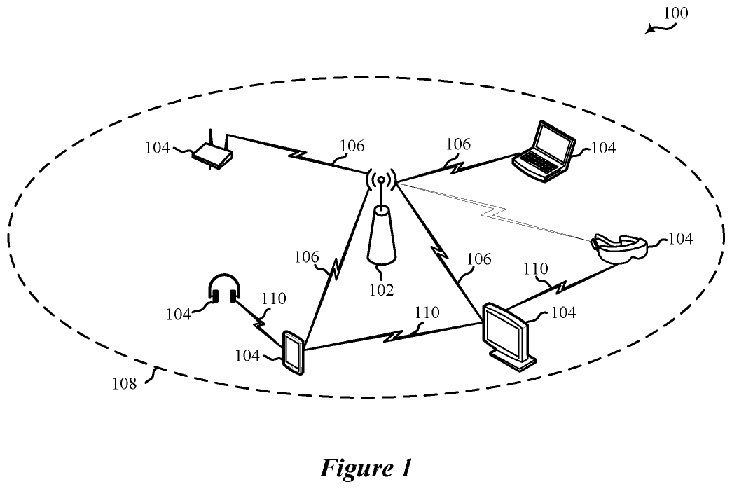

FIG. 1 shows a pictorial diagram of an example wireless communication network 100. According to some aspects, the wireless communication network 100 can be an example of a WLAN such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless AP 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some implementations, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some implementations, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

In some implementations, a first STA 104 may generate a message to be transmitted to a second STA 104. The first STA 104 may generate an XPAN control frame, an L3 header, and an L2 header to include in the message. The first STA 104 may transmit the message to the AP 102, and the AP 102 may forward the message to the second STA 104.

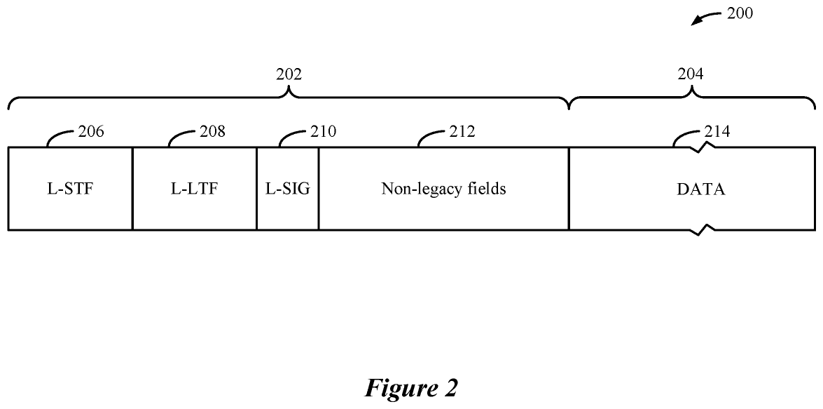

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

In some implementations, the DATA 214 may include a personal area network control frame (such as an XPAN control frame) and at least one network communication header (such as an L3 header and an L2 header).

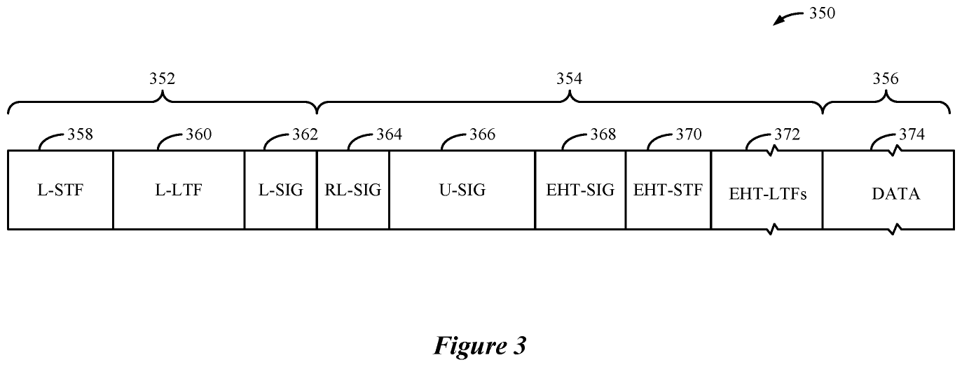

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as the AP 102 or the STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink (UL) or downlink (DL) resources for them. EHT-SIG 368 may be decoded by each compatible STA 104 served by the AP 102. EHT-SIG 368 may generally be used by the receiving device to interpret bits in the data field 374. For example, EHT-SIG 368 may include resource unit (RU) allocation information, spatial stream configuration information, and per-user (such as STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some implementations, the DATA 374 may include a personal area network control frame (such as an XPAN control frame) and at least one network communication header (such as an L3 header and an L2 header).

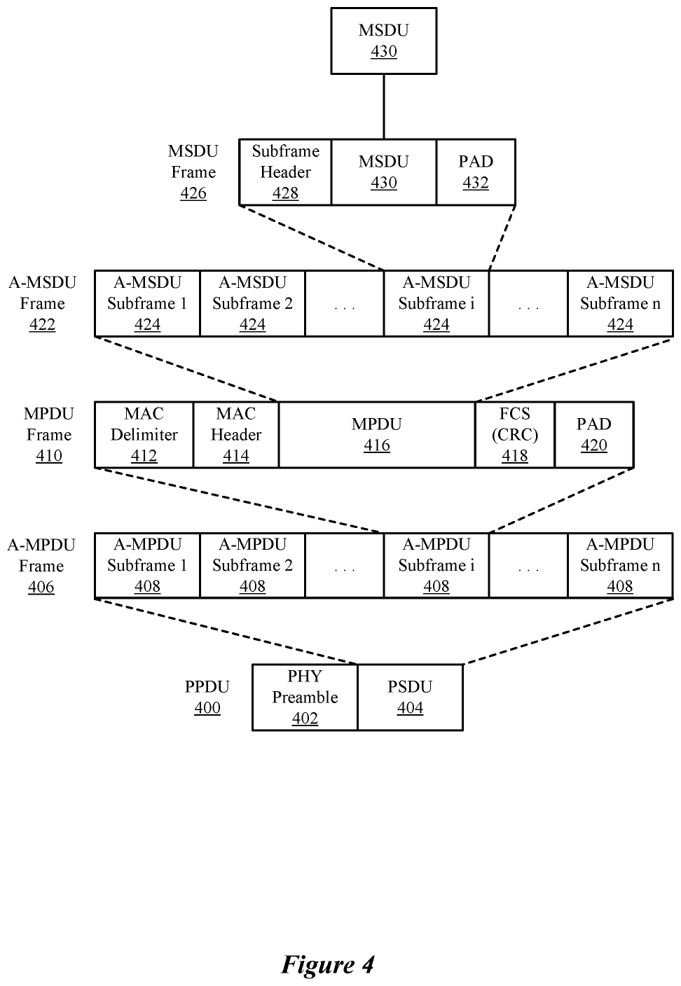

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 406 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (such as the FCS field may include a cyclic redundancy check (CRC)) and padding bits 420. The MPDU 416 may carry one or more MAC service data units (MSDUs) 416. For example, the MPDU 416 may carry an aggregated MSDU (A-MSDU) 422 including multiple A-MSDU subframes 424. Each A-MSDU subframe 424 may be associated with (such as an example of or otherwise referred to as) an MSDU frame 426 and may contain a corresponding MSDU 430 preceded by a subframe header 428 and in some cases followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body 416. The MAC header 414 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 414 also includes one or more fields indicating addresses for the data encapsulated within the frame body 416. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

In some implementations, the MPDU 416 may include a personal area network control frame (such as an XPAN control frame) and at least one network communication header (such as an L3 header and an L2 header).

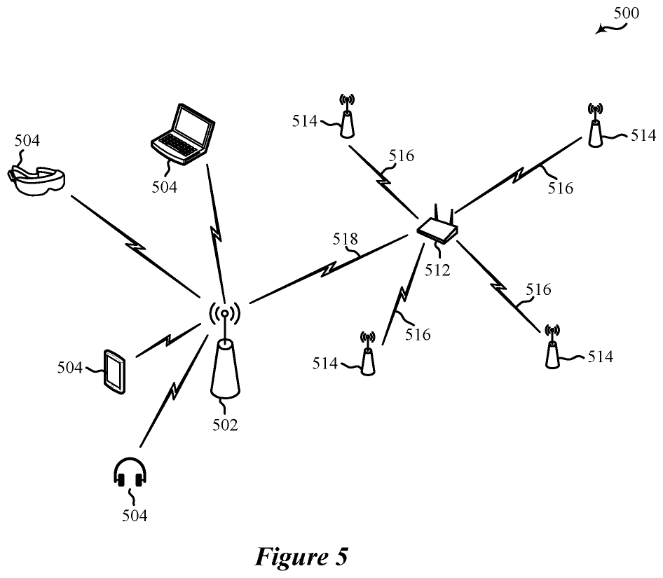

FIG. 5 shows a pictorial diagram of another example wireless communication network 500. According to some aspects, the wireless communication network 500 can be an example of a mesh network, an IoT network or a sensor network in accordance with one or more of the IEEE 802.11 family of wireless communication protocol standards (including the 802.11ah amendment). The wireless network 500 may include multiple wireless communication devices 514. The wireless communication devices 514 may represent various devices such as display devices (such as TVs, computer monitors, navigation systems, among others), music or other audio or stereo devices, remote control devices (“remotes”), printers, kitchen or other household appliances, among other examples.

In some implementations, the wireless communication devices 514 sense, measure, collect or otherwise obtain and process data and then transmit such raw or processed data to an intermediate device 512 for subsequent processing or distribution. Additionally, or alternatively, the intermediate device 512 may transmit control information, digital content (such as audio or video data), configuration information or other instructions to the wireless communication devices 514. The intermediate device 512 and the wireless communication devices 514 can communicate with one another via wireless communication links 516. In some implementations, the wireless communication links 516 include Bluetooth links or other PAN or short-range communication links.

In some implementations, the intermediate device 512 also may be configured for wireless communication with other networks such as with a Wi-Fi wireless communication network 100 or a wireless (such as cellular) wide area network (WWAN), which may, in turn, provide access to external networks including the Internet. For example, the intermediate device 512 may associate and communicate, over a Wi-Fi link 518, with an AP 502 of a WLAN network, which also may serve various STAs 504. In some implementations, the intermediate device 512 is an example of a network gateway, for example, an IoT gateway. In such a manner, the intermediate device 512 may serve as an edge network bridge providing a Wi-Fi core backhaul for the IoT network including the wireless communication devices 514. In some implementations, the intermediate device 512 can analyze, preprocess and aggregate data received from the wireless communication devices 514 locally at the edge before transmitting it to other devices or external networks via the Wi-Fi link 518. The intermediate device 512 also can provide additional security for the IoT network and the data it transports.

Aspects of transmissions may vary according to a distance between a transmitter (such as an AP 502 or a STA 504) and a receiver (such as another AP 502 or STA 504). Wireless communication devices (such as the AP 502 or the STA 504) may generally benefit from having information regarding the location or proximities of the various STAs 504 within the coverage area. In some implementations, relevant distances may be determined (such as calculated or computed) using RTT-based ranging procedures. Additionally, In some implementations, APs 502 and STAs 504 may perform ranging operations. Each ranging operation may involve an exchange of fine timing measurement (FTM) frames (such as those defined in the 802.11az amendment to the IEEE family of wireless communication protocol standards) to obtain measurements of RTT transmissions between the wireless communication devices.

In some implementations, a first STA 504 may generate a message to be transmitted to a second STA 504. The first STA 504 may generate an XPAN control frame, an L3 header, and an L2 header to include in the message. The first STA 504 may transmit the message to the AP 502, and the AP 102 may forward the message to the second STA 504.

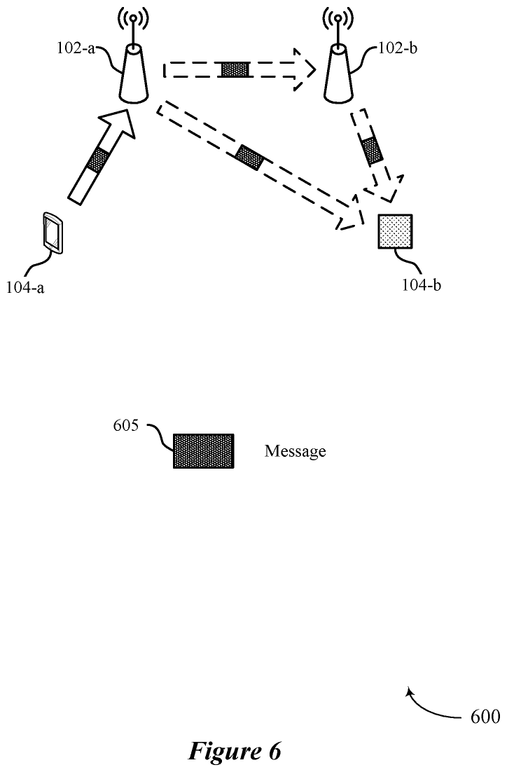

FIG. 6 shows a pictorial diagram of another example wireless communication network 600 that supports transport of XPAN control frames across networks. In some implementations, wireless communication network 600 may implement aspects of wireless communication network 100 and wireless communication network 500. For example, wireless communication network 600 includes a STA 104-a, a STA 104-b, an AP 102-a, and an AP 102-b, which may be examples of the corresponding devices described with reference to FIGS. 1 and 5. In some implementations, the STA 104-a may be a handset or user equipment (UE) and the STA 104-b may be a pair of ear buds, or vice versa.

The STA 104-a may generate a message 605 to transmit to the STA 104-b, for example, in response to receiving data from a server to forward to the STA 104-b. For example, the message 605 may contain audio or visual data. In some implementations, the STA 104-a and the STA 104-b may out of range of each other (such as greater than 10 meters apart), such that the distance between the STA 104-a and the STA 104-b is too great to transmit the message 605 directly (such as via a Bluetooth connection or a traditional WPAN network). Thus, the STA 104-a and the STA 104-b may participate in an XPAN to communicate data frames and control frames over LAN transport technologies such as Wi-Fi. An XPAN using WLAN as a transport (such as rather than WPAN) may span across large homes, office buildings and enterprises and does not rely on line-of-sight between two XPAN endpoint devices such as STA 104-a and STA 104-b. The message 605 may include one or more data frames and one or more control frames specific to XPAN networks.

The STA 104-a and the STA 104-b may operate in one of several connection topologies (such as one of several XPAN connection topologies) that may determine how the STA 104-a transmits and the STA 104-b receives the message 605. In a first example, the STA 104-a and the STA 104-b may be out of range, but in a same BSS (such as the STA 104-a and the STA 104-b may share a same L2 network and a same L3 network), where both the STA 104-a and the STA 104-b may be connected to the AP 102-a. The STA 104-a may transmit the message 605 to the AP 102-a, and the AP 102-a may forward the message 605 to the STA 104-b.

In a second example, the STA 104-a and the STA 104-b may be out of range and not in a same BSS, but in a same ESS, where the STA 104-a may be connected to the AP 102-a, the STA 104-b may be connected to the AP 102-b, and the STA 104-a and the STA 104-b share a same L3 network (such as use a same or bridged interface of an L3 router) and not share a same L2 network. The STA 104-a may transmit the message 605 to the AP 102-a, the AP 102-a may forward the message 605 to the AP 102-b (such as via the L3 router, or directly to the AP 102-b), and the AP-102-b may forward the message 605 to the STA 104-b.

In a third example, the STA 104-a and the STA 104-b may be out of range, in different L2 networks, and in different L3 networks, but located in a same environment (such as in a same home or office building). The STA 104-a may transmit the message 605 to the AP 102-a, the AP 102-a may forward the message 605 to one or more other devices that can connect to the two different L3 networks (such as an L3 router), the one or more other devices may forward the message 605 to the AP 102-b, and the AP 102-b may forward the message 605 to the STA 104-b.

In each of these example connection topologies, a mechanism may be desired to prioritize XPAN control frames when forwarding the XPAN control frames within a single L3 network or across multiple L3 networks, since current methods of inspecting the flow may be expensive operations. The XPAN control frames may include time synchronization frames exchanged between the STA 104-a and the STA 104-b, control messages sent using GATT protocol between two BLE endpoints, and 802.11 action frames such as vendor specific action frames, among other examples. The XPAN control frames may use an infrastructure to traverse networks from one endpoint in the XPAN network (such as the STA 104-a) to another endpoint in the XPAN network (such as the STA 104-b). In the first two example connection topologies, where the STA 104-a and the STA 104-b share an L3 network but not an L2 network, the XPAN network may employ L2 addressing to route the XPAN control frames. In the third example connection topology, where the STA 104-a and the STA 104-b do not share an L2 network or an L3 network, the XPAN network may employ L3 addressing to route the XPAN control frames.

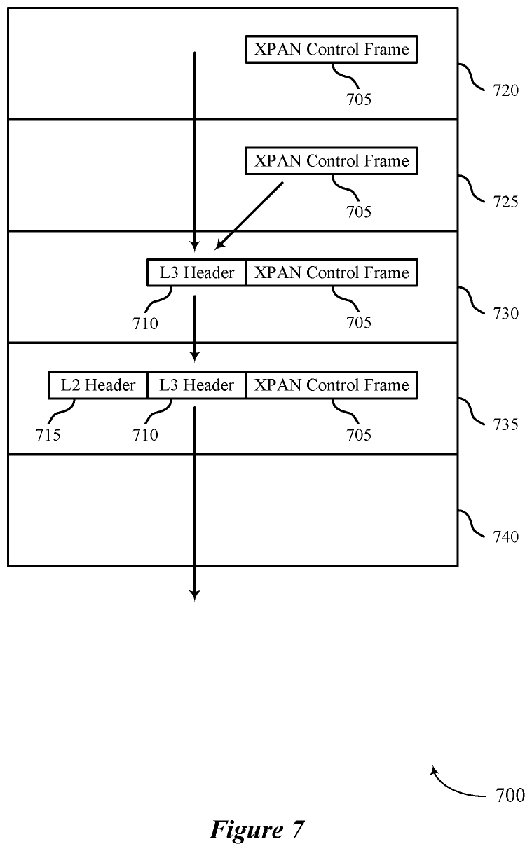

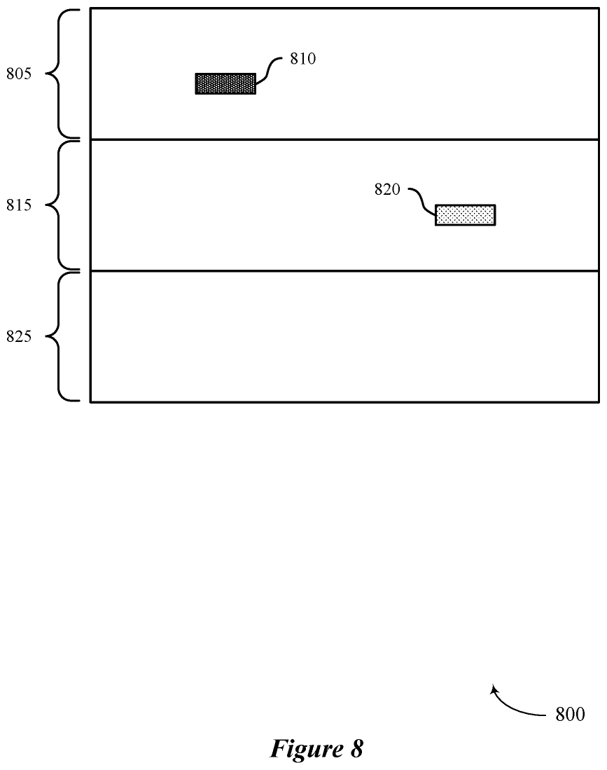

The STA 104-a may employ an IP encapsulated XPAN control frame (e.g., an XPAN control frame that is encapsulated using IPv4 or IPv6 and Ethernet) using L2 and L3 headers to prioritize XPAN control frames when forwarding the XPAN control frames within a single L3 network or across multiple L3 networks. This packetization process may be referred to as XPAN control over IP (XPAN-CoIP), and is described in more detail with reference to FIG. 7. Additional details regarding the XPAN control frames and the L2 and L3 headers may be found in the description of FIG. 8.

FIG. 7 shows a flowchart illustrating an example of a packetization process 700 that supports transport of XPAN control frames across networks. The packetization process 700 may be implemented by a wireless STA, such as the STA 104-a as described with reference to FIG. 6, to create an IP encapsulated control frame that may include an XPAN control frame 705, an L3 header 710, and an L2 header 715 via the kernel network stack. Alternative examples of the following may be implemented, where some steps are performed in a different order than described or are not performed at all. In some implementations, steps may include additional features not mentioned below, or further steps may be added.

The XPAN control frame 705 (such as an XPAN TSF control frame) may be generated by an XPAN application in the user space 720. Additionally, or alternatively, the XPAN control frame 705 may be generated by an XPAN kernel module in the kernel space 725. In another example, the XPAN control frame 705 may be generated at a raw socket of the STA. The XPAN control frame 705 may be combined with one or more network communication headers to form an IP encapsulated control frame.

For example, an L3 header 710 may be inserted in the IP encapsulated control frame via an L3/IP Stack 730 per an L3 configuration. The L3 header 710 may include one or more fields, such as IP addresses, length, protocol, and checksum.

Additionally, or alternatively, an L2 header 715 may be inserted in the IP encapsulated control frame via an L2/Ethernet stack 735 per an L2 configuration. The L2 header 715 may include one or more fields, such as MAC addresses and an Ethertype.

In some implementations, a peripheral driver 740 of the STA may perform custom processing on the IP encapsulated control frame before the STA transmits the IP encapsulated control frame on a physical interface. The contents of the IP encapsulated control frame may be described in more detail with reference to FIG. 8.

FIG. 8 shows an example of a packet format 800 that supports transport of XPAN control frames across networks. The packet format 800 may show an example of the IP encapsulated control frame described with reference to FIGS. 6, 7, and 9. In some implementations, a transmitting STA 104 may transmit a message to a receiving STA 104 (such as or to an AP 102 for forwarding to a receiving STA 104) that includes the packet format 800 that is encapsulated using an L2 header 805 and an L3 header 815.

The packet format 800 may include the L2 header 805, the L3 header 815, and a payload 825. The L2 header 805 may pertain to data link layer communications and may be an Ethernet header. The L2 header 805 may include one or more fields, such as an Ethertype 810 to indicate an Ethernet type (such as IPv4 or IPv6). Other fields included in the L2 header 805 may include a destination MAC address, a source MAC address, padding, and other fields. The L2 header 805 may be used in connection topologies in which the transmitting STA and the receiving STA are in the same L2 network (such as a same BSS or a same ESS), as described with reference to FIG. 6.

The L3 header 815 may pertain to network layer communications and may include one or more fields, such as an XPAN control frame field 820. In some implementations, the L3 header is an IPV4 header and the XPAN control frame field 820 may be a protocol field. The protocol field in the L3 IPv4 header may be of type XPAN control, indicating that the message includes the packet format 800. In some other implementations, the L3 header is an IPV6 header and the XPAN control frame field 820 may be an extension header field. The extension header field in the L3 IPv6 header may be of type XPAN control, indicating that the message includes the packet format 800. Other fields included in the L3 header 815 may include a version, a header length, a total length, a header checksum, a source IPv4 or IPv6 address, a destination IPv4 or IPv6 address, options, and other fields. The XPAN control frame field 820 may have a value of 0xAB, or come from a list of unassigned protocols. The L3 header 815 may be used in connection topologies in which the transmitting STA and the receiving STA do not share a same L2 network and the message may be routed across one or more L3 networks, as described with reference to FIG. 6.

The XPAN control frame field 820 (such as the XPAN control type in the protocol field of an IPV4 header or the extension header field of an IPV6 header) may allow for easy segregation of data at one or more processing nodes. In some implementations, the XPAN control frame field 820 may allow the message to bypass L4 at the endpoints and be delivered directly to a socket at an application. At intermediate routers and processing nodes (such as an AP 102), the custom encapsulation allows for prioritization of these packets without L4 processing. The transmitting STA 104 and the receiving STA 104 may use raw sockets to create, transmit, and receive the packet format 800.

The payload 825 may include a type field, a length field, and a type-specific payload field. The type field may be 2 bytes and may indicate the type of XPAN control message (such as TSF SYNC MESSAGE, TSF SYNC RESPONSE, TSF SYNC FOLLOWUP, TSF SYNC TIME, REQUEST SCAN LIST, SCAN RESULTS, or another message type). The length field may be 2 bytes and may indicate the total length, in bytes, of the payload 825, including the XPAN payload header (the type field and the length field) within the IPV4 or IPv6 packet. The length field may have a minimum value of 4 bytes, where the type-specific payload field is empty (such as in the case of a notification message with no parameters).

The type-specific payload field may have a variable content and length and may depend on the value of the type field. The size or length of the type-specific payload field may be limited by the length of the IP payload, since the XPAN payload 825 is encapsulated in an IP datagram. In some implementations, the size of the type-specific payload field is smaller than a full MTU-sized IP datagram, while in some other implementations—such as when the type field is “SCAN RESULTS”—the size of the type-specific payload field is relatively large. In one example, the type field may indicate a “TSF SYNC MESSAGE” message type, and the type-specific payload field may carry different timestamps depending on the source and destination. In another example, the type field may indicate a “REQUEST SCAN LIST” message type, and the type-specific payload field may include a list of channels. In another example, the type field may indicate a “SCAN RESULTS” message type, and the type-specific payload field may include BSSIDs and the channels in which they may be found. In some implementations, such as when the type field indicates a notification message such as a “ROAMING COMPLETION” message type, the type-specific payload field may be empty.

The format of the payload 825 as described herein may allow for flexibility and extensibility of using this framework for a wide variety of XPAN control frames.

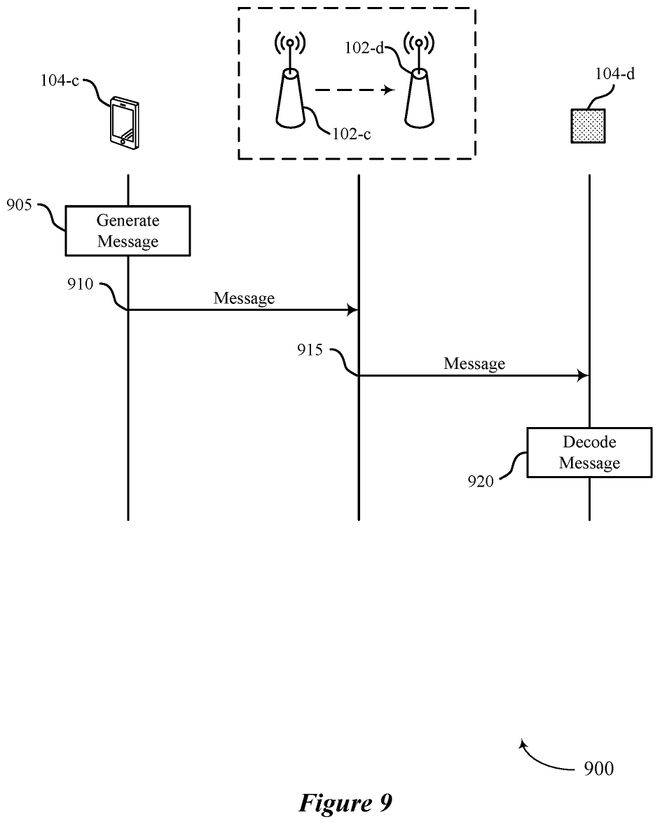

FIG. 9 shows an example of a process flow 900 that supports transport of XPAN control frames across networks. In some implementations, the process flow 900 may be implemented by, or may implement aspects of, the wireless communication network 100, the PDU 200, the PPDU 350, the PPDU 400, the wireless communication network 500, the wireless communication network 600, the packetization process 700, and the packet format 800. For example, the process flow 900 includes a STA 104-c, an AP 102-c, an AP 102-d, and a STA 104-d, which may be examples of the corresponding devices described with reference to FIGS. 1, 5, and 6. Following the process flow 900, the STA 104-c may transport an XPAN control frame to the STA 104. Alternative examples of the following may be implemented, where some steps are performed in a different order than described or are not performed at all. In some implementations, steps may include additional features not mentioned below, or further steps may be added. Although the STA 104-c, the AP 102-c, the AP 102-d, and the STA 104-d are shown performing the operations of the process flow 900, some aspects of some operations also may be performed by one or more other wireless devices.

In some implementations, the STA 104-c may identify a trigger to participate in XPAN communication with the STA 104-d. The trigger may include an identification that the message to be transmitted to the STA 104-d is one of a predetermined type of message. For example, the message may be a request scan list message, a scan results message, an IP/MAC address message, a roaming completion message, a TWT config empty message, a keep SAP link at low power message, a roaming request message, a pre-roaming request message, a pre-roaming ACK message, an audio link report message, an XPAN time sync message, or another type of message. In some implementations, the trigger may include receiving data to be forwarded to the STA 104-d.

At 905, the STA 104-c may generate a message to be transmitted to the STA 104-d that is in a personal area network (such as an XPAN) with the STA 104-c. The message may be generated in response to identifying a trigger to participate in XPAN communication with the STA 104-d. The message may include an XPAN control frame and at least one network communication header (such as an L3 header or an L2 header) associated with a second network that is different from the XPAN. The XPAN control frame may include a type field, a length of a payload, and the payload. The type field may indicate the type of the message (and thus the content and length of the payload), such as TSF SYNC MESSAGE, TSF SYNC RESPONSE, TSF SYNC, FOLLOWUP, TSF SYNC TIME, REQUEST SCAN LIST, SCAN RESULTS, or other message types. The XPAN control frame may be generated at a PAN application, a PAN kernel module, or a raw socket at the STA 104-c.

The STA 104-c may generate an L3 header as at least a part of the at least one network communications header. The L3 header may pertain to network layer communications. A combination of the XPAN control frame and the L3 header may be an IP encapsulated control frame. In some implementations, the L3 header may be an IPv4 header. The IPV4 header may include a protocol field that may indicate that the message includes the XPAN control frame. In some implementations, the L3 header may be an IPV6 header. The IPV6 header may include a next header field that may indicate that the message includes the XPAN control frame.

The STA 104-c may generate an L2 header as at least a part of the at least one network communications header. The L2 header may pertain to data link layer communications and may be in addition to the IP encapsulated control frame. The L2 header may include a field indicating an Ethernet type, where the Ethernet type may be either IPv4 or IPv6.

At 910, the STA 104-c may transmit, to the STA 104-d, the message generated at 905 via the second network. In some implementations, the second network may be an L2-bridged network, and the message may be transmitted via a same BSS or an ESS in the L2-bridged network in accordance with the L2 header. In some implementations, the second network is an L3 network, and the message may be transmitted via the L3 network in accordance with the L3 header.

In some implementations, the AP 102-c may receive the message from the STA 104-c. The AP 102-c may be included in the network associated with the at least one network communication header. In some examples, the AP 102-c may forward the message to the AP 102-d.

At 915, the AP 102-c (or the AP 102-d) may forward the message to the STA 104-d based on the message including the XPAN control frame. The message may be forwarded via a same BSS or ESS in an L2-bridged network in accordance with the L2 header. Additionally, or alternatively, the message may be forwarded via an L3 network in accordance with the L3 header.

At 920, the STA 104-d may decode the message based on the message including the XPAN control frame.

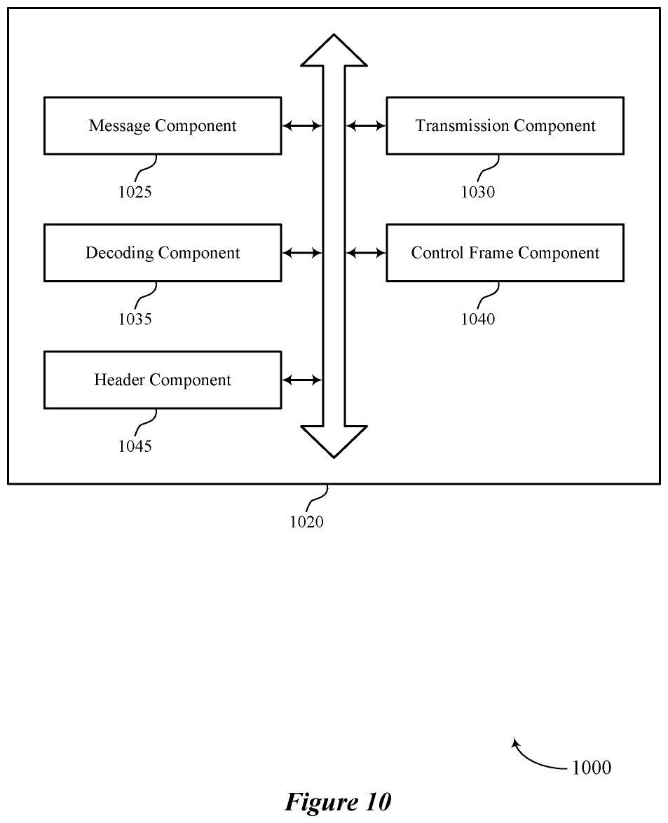

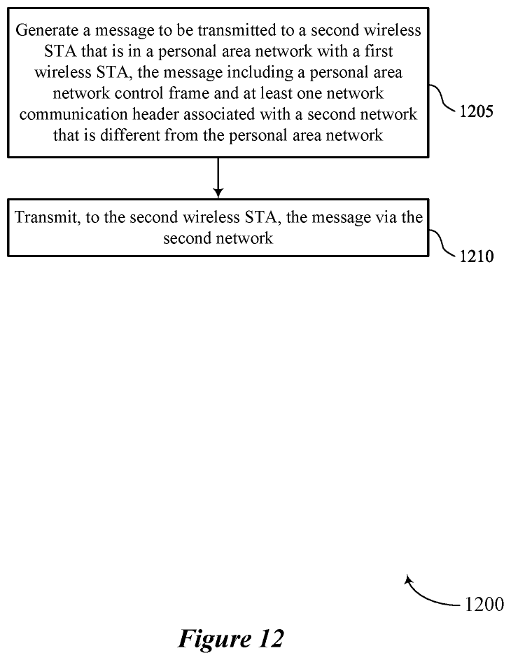

FIG. 10 shows a block diagram 1000 of an example wireless communication device 1020 that supports transport of XPAN control frames across networks. In some implementations, the wireless communication device 1020 is configured to perform the processes 1200, 1300, 1400, and 1600 described with reference to FIGS. 12, 13, 14, and 16, respectively. The wireless communication device 1020 may include one or more chips, SoCs, chipsets, packages, components or devices that individually or collectively constitute or include a processing system. The processing system may interface with other components of the wireless communication device 1020, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1020 may transmit the information output from the chip. In such an example, the second interface may refer to an interface between the processing system of the chip and a reception component, such that the wireless communication device 1020 may receive information that is then passed to the processing system. In some such examples, the first interface also may obtain information, such as from the transmission component, and the second interface also may output information, such as to the reception component.

The processing system of the wireless communication device 1020 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, In some implementations, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, the wireless communication device 1020 can configurable or configured for use in a STA, such as the STA 104 described with reference to FIG. 1. In some other examples, the wireless communication device 1020 can be a STA that includes such a processing system and other components including multiple antennas. The wireless communication device 1020 is capable of transmitting and receiving wireless communications in the form of, for example, wireless packets. For example, the wireless communication device 1020 can be configurable or configured to transmit and receive packets in the form of physical layer PPDUs and MPDUs conforming to one or more of the IEEE 802.11 family of wireless communication protocol standards. In some other examples, the wireless communication device 1020 can be configurable or configured to transmit and receive signals and communications conforming to one or more 3GPP specifications including those for 5G NR or 6G. In some implementations, the wireless communication device 1020 also includes or can be coupled with one or more application processors which may be further coupled with one or more other memories. In some implementations, the wireless communication device 1020 further includes a user interface (UI) (such as a touchscreen or keypad) and a display, which may be integrated with the UI to form a touchscreen display that is coupled with the processing system. In some implementations, the wireless communication device 1020 may further include one or more sensors such as, for example, one or more inertial sensors, accelerometers, temperature sensors, pressure sensors, or altitude sensors, that are coupled with the processing system.

The wireless communication device 1020 includes a message component 1025, a transmission component 1030, a decoding component 1035, a control frame component 1040, and a header component 1045. Portions of one or more of the message component 1025, the transmission component 1030, the decoding component 1035, the control frame component 1040, and the header component 1045 may be implemented at least in part in hardware or firmware. For example, one or more of the message component 1025, the transmission component 1030, the decoding component 1035, the control frame component 1040, and the header component 1045 may be implemented at least in part by at least a processor or a modem. In some implementations, portions of one or more of the message component 1025, the transmission component 1030, the decoding component 1035, the control frame component 1040, and the header component 1045 may be implemented at least in part by a processor and software in the form of processor-executable code stored in memory.

The wireless communication device 1020 may support wireless communications in accordance with examples as disclosed herein. The message component 1025 is configurable or configured to generate a message to be transmitted to a second wireless station that is in a personal area network with the first wireless station, the message including a personal area network control frame and at least one network communication header associated with a second network that is different from the personal area network. The transmission component 1030 is configurable or configured to transmit, to the second wireless station, the message via the second network.

In some implementations, to support generating the message, the control frame component 1040 is configurable or configured to generate the personal area network control frame at a personal area network application, a personal area network kernel module, or a raw socket at the first wireless station.

In some implementations, to support generating the message, the header component 1045 is configurable or configured to generate an L3 header as at least a part of the at least one network communication header, where the L3 header pertains to network layer communications, and where a combination of the personal area network control frame and the L3 header is an Internet Protocol (IP) encapsulated control frame.

In some implementations, the L3 header be an IPV4 header.

In some implementations, the IPv4 header include a protocol field which is indicative that the message includes the personal area network control frame.

In some implementations, the L3 header be an IPV6 header.

In some implementations, the IPv6 header include a next header field which is indicative that the message includes the personal area network control frame.

In some implementations, to support generating the message, the header component 1045 is configurable or configured to generate an L2 header as at least a part of the at least one network communication header, where the L2 header pertains to data link layer communications, and is in addition to the IP encapsulated control frame.

In some implementations, the L2 header include a field indicating an Ethernet type. In some implementations, the Ethernet type be one of IPV4 or IPv6.

In some implementations, to support transmitting the message via the second network, the transmission component 1030 is configurable or configured to transmit the message via a same BSS or an extended service set in an L2-bridged network in accordance with the L2 header, where the second network is the L2-bridged network.

In some implementations, to support transmitting the message via the second network, the transmission component 1030 is configurable or configured to transmit the message via an L3 network in accordance with the L3 header, where the second network is the L3 network.

In some implementations, the message component 1025 is configurable or configured to identify a trigger to participate in a personal area network communication with the second wireless station, where generation of the message to be transmitted to the second wireless station is based on identifying the trigger.

In some implementations, the trigger include an identification that the message to be transmitted to the second wireless station is one of a predetermined type of message.

In some implementations, the message component 1025 is configurable or configured to receive data to be forwarded to the second wireless station, where receipt of the data is the trigger.

In some implementations, the personal area network be an XPAN.

In some implementations, the personal area network control frame contain a type field, a length of a payload, and the payload.

Additionally, or alternatively, the wireless communication device 1020 may support wireless communications in accordance with examples as disclosed herein. In some implementations, the message component 1025 is configurable or configured to receive a message from a second wireless station that is in a personal area network with the first wireless station, where the message includes a personal area network control frame and at least one network communication header associated with a second network that is different from the personal area network, where the message is received via the second network. The decoding component 1035 is configurable or configured to decode the message based on the message including the personal area network control frame.

In some implementations, to support receiving the message, the header component 1045 is configurable or configured to receive an L3 header as at least a part of the at least one network communication header, where the L3 header pertains to network layer communications, and where a combination of the personal area network control frame and the L3 header is an IP encapsulated control frame.

In some implementations, the L3 header be an IPV4 header.

In some implementations, the IPv4 header include a protocol field which is indicative that the message includes the personal area network control frame.

In some implementations, to support receiving the message, the header component 1045 is configurable or configured to receive an L2 header as at least a part of the at least one network communication header, where the L2 header pertains to data link layer communications, and is in addition to the IP encapsulated control frame.

In some implementations, the L2 header include a field indicating an Ethernet type. In some implementations, the Ethernet type be one of IPV4 or IPv6.

In some implementations, to support receiving the message, the message component 1025 is configurable or configured to receive the message via a same BSS or an extended service set in an L2-bridged network in accordance with the L2 header, where the second network is the L2-bridged network.

In some implementations, to support receiving the message, the message component 1025 is configurable or configured to receive the message via an L3 network in accordance with the L3 header, where the second network is the L3 network.

In some implementations, the L3 header be an IPV6 header.

In some implementations, the IPV6 header include a next header field which is indicative that the message includes the personal area network control frame.

In some implementations, the personal area network be an XPAN.

In some implementations, the personal area network control frame contain a type field, a length of a payload, and the payload.

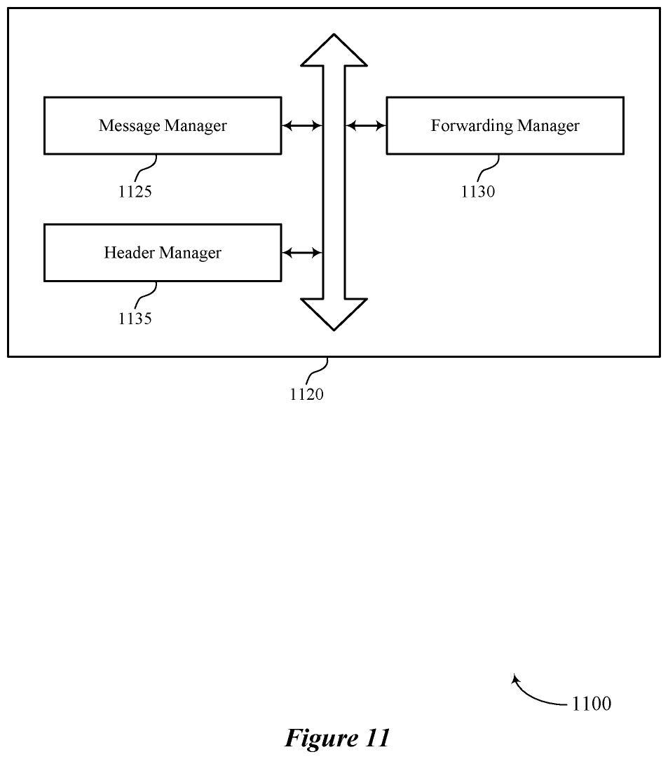

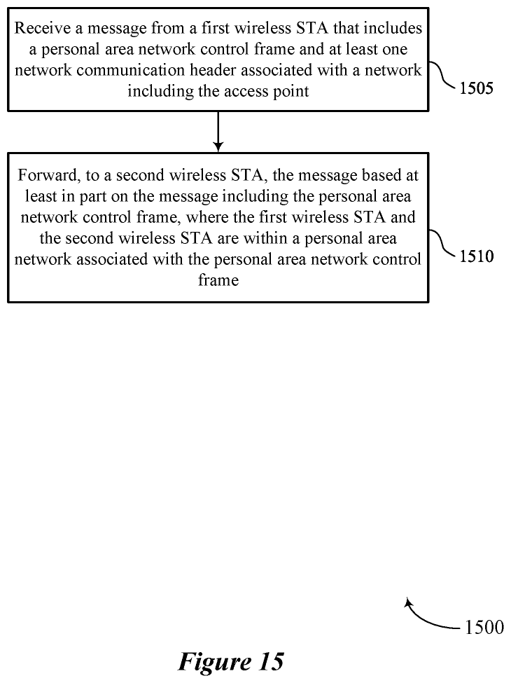

FIG. 11 shows a block diagram 1100 of an example wireless communication device 1120 that supports transport of XPAN control frames across networks. In some implementations, the wireless communication device 1120 is configured to perform the process 1500 described with reference to FIG. 15. The wireless communication device 1120 may include one or more chips, SoCs, chipsets, packages, components or devices that individually or collectively constitute or include a processing system. The processing system may interface with other components of the wireless communication device 1120, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1120 may transmit the information output from the chip. In such an example, the second interface may refer to an interface between the processing system of the chip and a reception component, such that the wireless communication device 1120 may receive information that is then passed to the processing system. In some such examples, the first interface also may obtain information, such as from the transmission component, and the second interface also may output information, such as to the reception component.

The processing system of the wireless communication device 1120 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, In some implementations, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, the wireless communication device 1120 can configurable or configured for use in an AP, such as the AP 102 described with reference to FIG. 1. In some other examples, the wireless communication device 1120 can be an AP that includes such a processing system and other components including multiple antennas. The wireless communication device 1120 is capable of transmitting and receiving wireless communications in the form of, for example, wireless packets. For example, the wireless communication device 1120 can be configurable or configured to transmit and receive packets in the form of physical layer PPDUs and MPDUs conforming to one or more of the IEEE 802.11 family of wireless communication protocol standards. In some other examples, the wireless communication device 1120 can be configurable or configured to transmit and receive signals and communications conforming to one or more 3GPP specifications including those for 5G NR or 6G. In some implementations, the wireless communication device 1120 also includes or can be coupled with one or more application processors which may be further coupled with one or more other memories. In some implementations, the wireless communication device 1120 further includes at least one external network interface coupled with the processing system that enables communication with a core network or backhaul network that enables the wireless communication device 1120 to gain access to external networks including the Internet.

The wireless communication device 1120 includes a message manager 1125, a forwarding manager 1130, and a header manager 1135. Portions of one or more of the message manager 1125, the forwarding manager 1130, and the header manager 1135 may be implemented at least in part in hardware or firmware. For example, one or more of the message manager 1125, the forwarding manager 1130, and the header manager 1135 may be implemented at least in part by at least a processor or a modem. In some implementations, portions of one or more of the message manager 1125, the forwarding manager 1130, and the header manager 1135 may be implemented at least in part by a processor and software in the form of processor-executable code stored in memory.

The wireless communication device 1120 may support wireless communications in accordance with examples as disclosed herein. The message manager 1125 is configurable or configured to receive a message from a first wireless station that includes a personal area network control frame and at least one network communication header associated with a network including the AP. The forwarding manager 1130 is configurable or configured to forwarding, to a second wireless station, the message based at least in part on the message including the personal area network control frame, where the first wireless station and the second wireless station are within a personal area network associated with the personal area network control frame.

In some implementations, to support receiving the message, the header manager 1135 is configurable or configured to receive an L3 header as at least a part of the at least one network communication header, where the L3 header pertains to network layer communications, and where a combination of the personal area network control frame and the L3 header is an IP encapsulated control frame.

In some implementations, the L3 header be an IPV4 header.

In some implementations, the IPv4 header include a protocol field which is indicative that the message includes the personal area network control frame.

In some implementations, the L3 header be an IPV6 header.

In some implementations, the IPv6 header include a next header field which is indicative that the message includes the personal area network control frame.

In some implementations, to support receiving the message, the header manager 1135 is configurable or configured to receive an L2 header as at least a part of the at least one network communication header, where the L2 header pertains to data link layer communications, and is in addition to the IP encapsulated control frame.

In some implementations, the L2 header include a field indicating an Ethernet type. In some implementations, the Ethernet type be one of IPV4 or IPv6.

In some implementations, to support forwarding the message, the forwarding manager 1130 is configurable or configured to forward the message via a same BSS or an extended service set in an L2-bridged network in accordance with the L2 header, where the network is the L2-bridged network.

In some implementations, to support forwarding the message, the forwarding manager 1130 is configurable or configured to forward the message via an L3 network in accordance with the L3 header, where the network is the L3 network.

In some implementations, the personal area network be an XPAN.

In some implementations, the personal area network control frame contain a type field, a length of a payload, and the payload.

FIG. 12 shows a flowchart illustrating an example process 1200 performable by or at a first wireless station that supports transport of XPAN control frames across networks. The operations of the process 1200 may be implemented by a first wireless station or its components as described herein. For example, the process 1200 may be performed by a wireless communication device, such as the wireless communication device 1020 described with reference to FIG. 10, operating as or within a wireless STA. In some implementations, the process 1200 may be performed by a wireless STA, such as one of the STAs 104 described with reference to FIG. 1.

In some implementations, in block 1205, the first wireless station may generate a message to be transmitted to a second wireless station that is in a personal area network with the first wireless station, the message including a personal area network control frame and at least one network communication header associated with a second network that is different from the personal area network. The operations of block 1205 may be performed in accordance with examples as disclosed herein. In some implementations, aspects of the operations of block 1205 may be performed by a message component 1025 as described with reference to FIG. 10.

In some implementations, in block 1210, the first wireless station may transmit, to the second wireless station, the message via the second network. The operations of block 1210 may be performed in accordance with examples as disclosed herein. In some implementations, aspects of the operations of block 1210 may be performed by a transmission component 1030 as described with reference to FIG. 10.

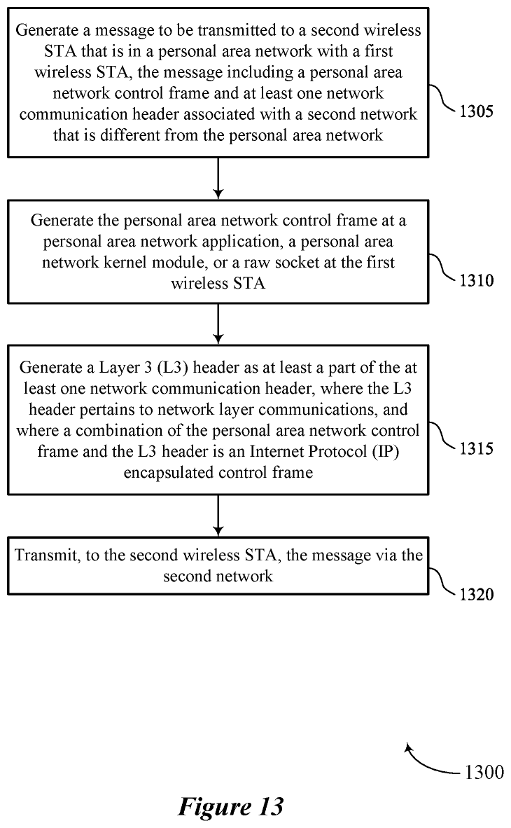

FIG. 13 shows a flowchart illustrating an example process 1300 performable by or at a first wireless station that supports transport of XPAN control frames across networks. The operations of the process 1300 may be implemented by a first wireless station or its components as described herein. For example, the process 1300 may be performed by a wireless communication device, such as the wireless communication device 1020 described with reference to FIG. 10, operating as or within a wireless STA. In some implementations, the process 1300 may be performed by a wireless STA, such as one of the STAs 104 described with reference to FIG. 1.

In some implementations, in block 1305, the first wireless station may generate a message to be transmitted to a second wireless station that is in a personal area network with the first wireless station, the message including a personal area network control frame and at least one network communication header associated with a second network that is different from the personal area network. The operations of block 1305 may be performed in accordance with examples as disclosed herein. In some implementations, aspects of the operations of block 1305 may be performed by a message component 1025 as described with reference to FIG. 10.

In some implementations, in block 1310, the first wireless station may generate the personal area network control frame at a personal area network application, a personal area network kernel module, or a raw socket at the first wireless station. The operations of block 1310 may be performed in accordance with examples as disclosed herein. In some implementations, aspects of the operations of block 1310 may be performed by a control frame component 1040 as described with reference to FIG. 10.

In some implementations, in block 1315, the first wireless station may generate an L3 header as at least a part of the at least one network communication header, where the L3 header pertains to network layer communications, and where a combination of the personal area network control frame and the L3 header is an IP encapsulated control frame. The operations of block 1315 may be performed in accordance with examples as disclosed herein. In some implementations, aspects of the operations of block 1315 may be performed by a header component 1045 as described with reference to FIG. 10.

In some implementations, in block 1320, the first wireless station may transmit, to the second wireless station, the message via the second network. The operations of block 1320 may be performed in accordance with examples as disclosed herein. In some implementations, aspects of the operations of block 1320 may be performed by a transmission component 1030 as described with reference to FIG. 10.

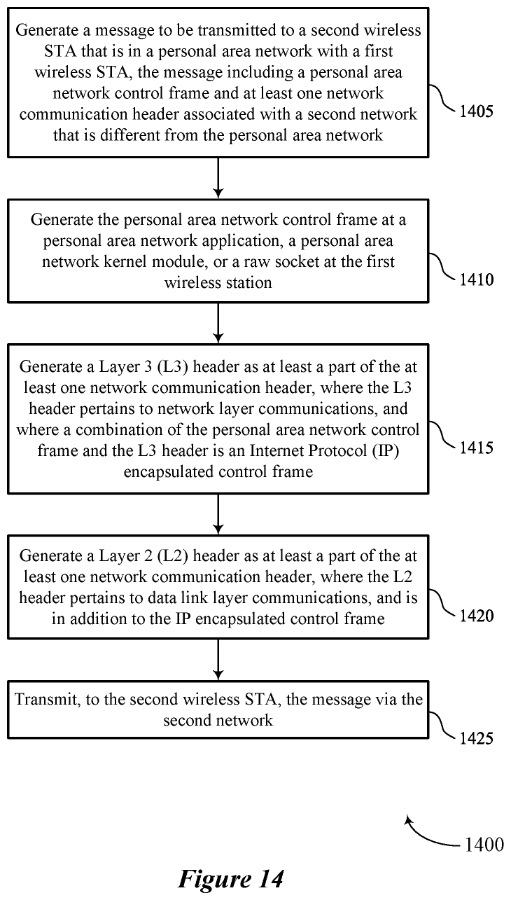

FIG. 14 shows a flowchart illustrating an example process 1400 performable by or at a first wireless station that supports transport of XPAN control frames across networks. The operations of the process 1400 may be implemented by a first wireless station or its components as described herein. For example, the process 1400 may be performed by a wireless communication device, such as the wireless communication device 1020 described with reference to FIG. 10, operating as or within a wireless STA. In some implementations, the process 1400 may be performed by a wireless STA, such as one of the STAs 104 described with reference to FIG. 1.

In some implementations, in block 1405, the first wireless station may generate a message to be transmitted to a second wireless station that is in a personal area network with the first wireless station, the message including a personal area network control frame and at least one network communication header associated with a second network that is different from the personal area network. The operations of block 1405 may be performed in accordance with examples as disclosed herein. In some implementations, aspects of the operations of block 1405 may be performed by a message component 1025 as described with reference to FIG. 10.

In some implementations, in block 1410, the first wireless station may generate the personal area network control frame at a personal area network application, a personal area network kernel module, or a raw socket at the first wireless station. The operations of block 1410 may be performed in accordance with examples as disclosed herein. In some implementations, aspects of the operations of block 1410 may be performed by a control frame component 1040 as described with reference to FIG. 10.

In some implementations, in block 1415, the first wireless station may generate an L3 header as at least a part of the at least one network communication header, where the L3 header pertains to network layer communications, and where a combination of the personal area network control frame and the L3 header is an IP encapsulated control frame. The operations of block 1415 may be performed in accordance with examples as disclosed herein. In some implementations, aspects of the operations of block 1415 may be performed by a header component 1045 as described with reference to FIG. 10.

In some implementations, in block 1420, the first wireless station may generate an L2 header as at least a part of the at least one network communication header, where the L2 header pertains to data link layer communications, and is in addition to the IP encapsulated control frame. The operations of block 1420 may be performed in accordance with examples as disclosed herein. In some implementations, aspects of the operations of block 1420 may be performed by a header component 1045 as described with reference to FIG. 10.

In some implementations, in block 1425, the first wireless station may transmit, to the second wireless station, the message via the second network. The operations of block 1425 may be performed in accordance with examples as disclosed herein. In some implementations, aspects of the operations of block 1425 may be performed by a transmission component 1030 as described with reference to FIG. 10.

FIG. 15 shows a flowchart illustrating an example process 1500 performable by or at an AP that supports transport of XPAN control frames across networks. The operations of the process 1500 may be implemented by an AP or its components as described herein. For example, the process 1500 may be performed by a wireless communication device, such as the wireless communication device 1120 described with reference to FIG. 11, operating as or within a wireless AP. In some implementations, the process 1500 may be performed by a wireless AP, such as one of the APs 102 described with reference to FIG. 1.

In some implementations, in block 1505, the AP may receive a message from a first wireless station that includes a personal area network control frame and at least one network communication header associated with a network including the AP. The operations of block 1505 may be performed in accordance with examples as disclosed herein. In some implementations, aspects of the operations of block 1505 may be performed by a message manager 1125 as described with reference to FIG. 11.

In some implementations, in block 1510, the AP may forwarding, to a second wireless station, the message based at least in part on the message including the personal area network control frame, where the first wireless station and the second wireless station are within a personal area network associated with the personal area network control frame. The operations of block 1510 may be performed in accordance with examples as disclosed herein. In some implementations, aspects of the operations of block 1510 may be performed by a forwarding manager 1130 as described with reference to FIG. 11.

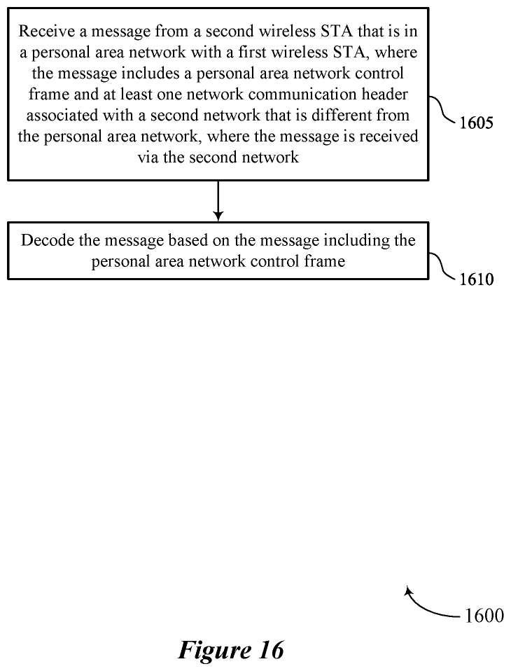

FIG. 16 shows a flowchart illustrating an example process 1600 performable by or at a first wireless station that supports transport of XPAN control frames across networks. The operations of the process 1600 may be implemented by a first wireless station or its components as described herein. For example, the process 1600 may be performed by a wireless communication device, such as the wireless communication device 1020 described with reference to FIG. 10, operating as or within a wireless STA. In some implementations, the process 1600 may be performed by a wireless STA, such as one of the STAs 104 described with reference to FIG. 1.

In some implementations, in block 1605, the first wireless station may receive a message from a second wireless station that is in a personal area network with the first wireless station, where the message includes a personal area network control frame and at least one network communication header associated with a second network that is different from the personal area network, where the message is received via the second network. The operations of block 1605 may be performed in accordance with examples as disclosed herein. In some implementations, aspects of the operations of block 1605 may be performed by a message component 1025 as described with reference to FIG. 10.

In some implementations, in block 1610, the first wireless station may decode the message based on the message including the personal area network control frame. The operations of block 1610 may be performed in accordance with examples as disclosed herein. In some implementations, aspects of the operations of block 1610 may be performed by a decoding component 1035 as described with reference to FIG. 10.

Implementation examples are described in the following numbered clauses:

Aspect 1: A method for wireless communications at a first wireless station, comprising: generating a message to be transmitted to a second wireless station that is in a personal area network with the first wireless station, the message including a personal area network control frame and at least one network communication header associated with a second network that is different from the personal area network; and transmitting, to the second wireless station, the message via the second network.

Aspect 2: The method of aspect 1, wherein generating the message comprises: generating the personal area network control frame at a personal area network application, a personal area network kernel module, or a raw socket at the first wireless station.

Aspect 3: The method of aspect 2, wherein generating the message comprises: generating a Layer 3 (L3) header as at least a part of the at least one network communication header, wherein the L3 header pertains to network layer communications, and wherein a combination of the personal area network control frame and the L3 header is an Internet Protocol (IP) encapsulated control frame.

Aspect 4: The method of aspect 3, wherein the L3 header is an IP Version 4 (IPv4) header.

Aspect 5: The method of aspect 4, wherein the IPv4 header includes a protocol field which is indicative that the message includes the personal area network control frame.

Aspect 6: The method of aspect 3, wherein the L3 header is an IP Version 6 (IPv6) header.

Aspect 7: The method of aspect 6, wherein the IPV6 header includes a next header field which is indicative that the message includes the personal area network control frame.

Aspect 8: The method of any of aspects 3 through 7, wherein generating the message comprises: generating a Layer 2 (L2) header as at least a part of the at least one network communication header, wherein the L2 header pertains to data link layer communications, and is in addition to the IP encapsulated control frame.

Aspect 9: The method of aspect 8, wherein the L2 header includes a field indicating an Ethernet type, the Ethernet type is one of IP Version 4 (IPv4) or IP Version 6 (IPv6).

Aspect 10: The method of any of aspects 8 through 9, wherein transmitting the message via the second network comprises: transmitting the message via a same basic service set or an extended service set in an L2-bridged network in accordance with the L2 header, wherein the second network is the L2-bridged network.

Aspect 11: The method of any of aspects 8 through 10, wherein transmitting the message via the second network comprises: transmitting the message via an L3 network in accordance with the L3 header, wherein the second network is the L3 network.

Aspect 12: The method of any of aspects 1 through 11, further comprising: identifying a trigger to participate in a personal area network communication with the second wireless station, wherein generation of the message to be transmitted to the second wireless station is based at least in part on identifying the trigger.

Aspect 13: The method of aspect 12, wherein the trigger includes an identification that the message to be transmitted to the second wireless station is one of a predetermined type of message.

Aspect 14: The method of any of aspects 12 through 13, further comprising: receiving data to be forwarded to the second wireless station, wherein receipt of the data is the trigger.

Aspect 15: The method of any of aspects 1 through 14, wherein the personal area network is an extended personal area network (XPAN).

Aspect 16: The method of any of aspects 1 through 15, wherein the personal area network control frame contains a type field, a length of a payload, and the payload.

Aspect 17: A method for wireless communications at an access point, comprising: receiving a message from a first wireless station that includes a personal area network control frame and at least one network communication header associated with a network including the access point; and forwarding, to a second wireless station, the message based at least in part on the message including the personal area network control frame, wherein the first wireless station and the second wireless station are within a personal area network associated with the personal area network control frame.

Aspect 18: The method of aspect 17, wherein receiving the message comprises: receiving a Layer 3 (L3) header as at least a part of the at least one network communication header, wherein the L3 header pertains to network layer communications, and wherein a combination of the personal area network control frame and the L3 header is an Internet Protocol (IP) encapsulated control frame.

Aspect 19: The method of aspect 18, wherein the L3 header is an IP Version 4 (IPv4) header.

Aspect 20: The method of aspect 19, wherein the IPV4 header includes a protocol field which is indicative that the message includes the personal area network control frame.

Aspect 21: The method of aspect 18, wherein the L3 header is an IP Version 6 (IPv6) header.

Aspect 22: The method of aspect 21, wherein the IPV6 header includes a next header field which is indicative that the message includes the personal area network control frame.

Aspect 23: The method of any of aspects 18 through 22, wherein receiving the message comprises: receiving a Layer 2 (L2) header as at least a part of the at least one network communication header, wherein the L2 header pertains to data link layer communications, and is in addition to the IP encapsulated control frame.

Aspect 24: The method of aspect 23, wherein the L2 header includes a field indicating an Ethernet type, the Ethernet type is one of IP Version 4 (IPv4) or IP Version 6 (IPv6).

Aspect 25: The method of any of aspects 23 through 24, wherein forwarding the message comprises: forwarding the message via a same basic service set or an extended service set in an L2-bridged network in accordance with the L2 header, wherein the network is the L2-bridged network.

Aspect 26: The method of any of aspects 23 through 25, wherein forwarding the message comprises: forwarding the message via an L3 network in accordance with the L3 header, wherein the network is the L3 network.

Aspect 27: The method of any of aspects 17 through 26, wherein the personal area network is an extended personal area network (XPAN).

Aspect 28: The method of any of aspects 17 through 27, wherein the personal area network control frame contains a type field, a length of a payload, and the payload.

Aspect 29: A method for wireless communications at a first wireless station, comprising: receiving a message from a second wireless station that is in a personal area network with the first wireless station, wherein the message includes a personal area network control frame and at least one network communication header associated with a second network that is different from the personal area network, wherein the message is received via the second network; and decoding the message based at least in part on the message including the personal area network control frame.

Aspect 30: The method of aspect 29, wherein receiving the message comprises: receiving a Layer 3 (L3) header as at least a part of the at least one network communication header, wherein the L3 header pertains to network layer communications, and wherein a combination of the personal area network control frame and the L3 header is an Internet Protocol (IP) encapsulated control frame.

Aspect 31: The method of aspect 30, wherein the L3 header is an IP Version 4 (IPv4) header.

Aspect 32: The method of aspect 31, wherein the IPV4 header includes a protocol field which is indicative that the message includes the personal area network control frame.

Aspect 33: The method of any of aspects 31 through 32, wherein receiving the message comprises: receiving a Layer 2 (L2) header as at least a part of the at least one network communication header, wherein the L2 header pertains to data link layer communications, and is in addition to the IP encapsulated control frame.

Aspect 34: The method of aspect 33, wherein the L2 header includes a field indicating an Ethernet type, the Ethernet type is one of IP Version 4 (IPv4) or IP Version 6 (IPv6).

Aspect 35: The method of any of aspects 33 through 34, wherein receiving the message comprises: receiving the message via a same basic service set or an extended service set in an L2-bridged network in accordance with the L2 header, wherein the second network is the L2-bridged network.

Aspect 36: The method of any of aspects 33 through 35, wherein receiving the message comprises: receiving the message via an L3 network in accordance with the L3 header, wherein the second network is the L3 network.

Aspect 37: The method of any of aspects 30 through 36, wherein the L3 header is an IP Version 6 (IPv6) header.

Aspect 38: The method of aspect 37, wherein the IPV6 header includes a next header field which is indicative that the message includes the personal area network control frame.

Aspect 39: The method of any of aspects 29 through 38, wherein the personal area network is an extended personal area network (XPAN).

Aspect 40: The method of any of aspects 29 through 39, wherein the personal area network control frame contains a type field, a length of a payload, and the payload.

Aspect 41: A first wireless station for wireless communications, comprising one or more memories storing processor-executable code, and one or more processors coupled with the one or more memories and individually or collectively operable to execute the code to cause the first wireless station to perform a method of any of aspects 1 through 16.

Aspect 42: A first wireless station for wireless communications, comprising at least one means for performing a method of any of aspects 1 through 16.

Aspect 43: A non-transitory computer-readable medium storing code for wireless communications, the code comprising instructions executable by a processor to perform a method of any of aspects 1 through 16.

Aspect 44: An access point for wireless communications, comprising one or more memories storing processor-executable code, and one or more processors coupled with the one or more memories and individually or collectively operable to execute the code to cause the access point to perform a method of any of aspects 17 through 28.

Aspect 45: An access point for wireless communications, comprising at least one means for performing a method of any of aspects 17 through 28.

Aspect 46: A non-transitory computer-readable medium storing code for wireless communications, the code comprising instructions executable by a processor to perform a method of any of aspects 17 through 28.

Aspect 47: A first wireless station for wireless communications, comprising one or more memories storing processor-executable code, and one or more processors coupled with the one or more memories and individually or collectively operable to execute the code to cause the first wireless station to perform a method of any of aspects 29 through 40.

Aspect 48: A first wireless station for wireless communications, comprising at least one means for performing a method of any of aspects 29 through 40.

Aspect 49: A non-transitory computer-readable medium storing code for wireless communications, the code comprising instructions executable by a processor to perform a method of any of aspects 29 through 40.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a’,” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless station, comprising:
a processing system that includes processor circuitry and memory circuitry that stores code, the processing system configured to cause the first wireless station to:
generate a message to be transmitted to a second wireless station that is in a personal area network with the first wireless station, the message including a personal area network control frame and at least one network communication header associated with a second network that is different from the personal area network; and
transmit, to the second wireless station, the message via the second network.

2. The first wireless station of claim 1, wherein, to generate the message, the processing system is configured to cause the first wireless station to:
generate the personal area network control frame at a personal area network application, a personal area network kernel module, or a raw socket at the first wireless station.

3. The first wireless station of claim 2, wherein, to generate the message, the processing system is configured to cause the first wireless station to:
generate a Layer 3 (L3) header as at least a part of the at least one network communication header, wherein the L3 header pertains to network layer communications, and wherein a combination of the personal area network control frame and the L3 header is an Internet Protocol (IP) encapsulated control frame.

4. The first wireless station of claim 3, wherein the L3 header is an IP Version 4 (IPv4) header.

5. The first wireless station of claim 4, wherein the IPV4 header includes a protocol field which is indicative that the message includes the personal area network control frame.

6. The first wireless station of claim 3, wherein the L3 header is an IP Version 6 (IPv6) header.

7. The first wireless station of claim 6, wherein the IPV6 header includes a next header field which is indicative that the message includes the personal area network control frame.

8. The first wireless station of claim 3, wherein, to generate the message, the processing system is configured to cause the first wireless station to:
generate a Layer 2 (L2) header as at least a part of the at least one network communication header, wherein the L2 header pertains to data link layer communications, and is in addition to the IP encapsulated control frame.

9. The first wireless station of claim 8, wherein:
the L2 header includes a field indicating an Ethernet type, and
the Ethernet type is one of IP Version 4 (IPv4) or IP Version 6 (IPv6).

10. The first wireless station of claim 8, wherein, to transmit the message via the second network, the processing system is configured to cause the first wireless station to:
transmit the message via a same basic service set or an extended service set in an L2-bridged network in accordance with the L2 header, wherein the second network is the L2-bridged network.

11. The first wireless station of claim 8, wherein, to transmit the message via the second network, the processing system is configured to cause the first wireless station to:
transmit the message via an L3 network in accordance with the L3 header, wherein the second network is the L3 network.

12. The first wireless station of claim 1, wherein the processing system is further configured to cause the first wireless station to:
identify a trigger to participate in a personal area network communication with the second wireless station, wherein generation of the message to be transmitted to the second wireless station is based at least in part on identifying the trigger.

13. The first wireless station of claim 12, wherein the trigger includes an identification that the message to be transmitted to the second wireless station is one of a predetermined type of message.

14. The first wireless station of claim 12, wherein the processing system is further configured to cause the first wireless station to:
receive data to be forwarded to the second wireless station, wherein receipt of the data is the trigger.

15. The first wireless station of claim 1, wherein the personal area network is an extended personal area network (XPAN).

16. The first wireless station of claim 1, wherein the personal area network control frame contains a type field, a length of a payload, and the payload.

17. An access point, comprising:
a processing system that includes processor circuitry and memory circuitry that stores code, the processing system configured to cause the access point to:
receive a message from a first wireless station that includes a personal area network control frame and at least one network communication header associated with a network including the access point; and
forwarding, to a second wireless station, the message based at least in part on the message including the personal area network control frame, wherein the first wireless station and the second wireless station are within a personal area network associated with the personal area network control frame.

18. The access point of claim 17, wherein, to receive the message, the processing system is configured to cause the access point to:
receive a Layer 3 (L3) header as at least a part of the at least one network communication header, wherein the L3 header pertains to network layer communications, and wherein a combination of the personal area network control frame and the L3 header is an Internet Protocol (IP) encapsulated control frame.

19. The access point of claim 18, wherein, to receive the message, the processing system is configured to cause the access point to:
receive a Layer 2 (L2) header as at least a part of the at least one network communication header, wherein the L2 header pertains to data link layer communications, and is in addition to the IP encapsulated control frame.

20. The access point of claim 19, wherein, to forward the message, the processing system is configured to cause the access point to:
forward the message via a same basic service set or an extended service set in an L2-bridged network in accordance with the L2 header, wherein the network is the L2-bridged network.

21. The access point of claim 19, wherein, to forward the message, the processing system is configured to cause the access point to:
forward the message via an L3 network in accordance with the L3 header, wherein the network is the L3 network.

22. A first wireless station, comprising:
a processing system that includes processor circuitry and memory circuitry that stores code, the processing system configured to cause the first wireless station to:
receive a message from a second wireless station that is in a personal area network with the first wireless station, wherein the message includes a personal area network control frame and at least one network communication header associated with a second network that is different from the personal area network, wherein the message is received via the second network; and
decode the message based at least in part on the message including the personal area network control frame.

23. The first wireless station of claim 22, wherein, to receive the message, the processing system is configured to cause the first wireless station to:
receive a Layer 3 (L3) header as at least a part of the at least one network communication header, wherein the L3 header pertains to network layer communications, and wherein a combination of the personal area network control frame and the L3 header is an Internet Protocol (IP) encapsulated control frame.

24. The first wireless station of claim 23, wherein the L3 header is an IP Version 4 (IPv4) header.

25. The first wireless station of claim 24, wherein the IPV4 header includes a protocol field which is indicative that the message includes the personal area network control frame.

26. The first wireless station of claim 24, wherein, to receive the message, the processing system is configured to cause the first wireless station to:
receive a Layer 2 (L2) header as at least a part of the at least one network communication header, wherein the L2 header pertains to data link layer communications, and is in addition to the IP encapsulated control frame.

27. The first wireless station of claim 26, wherein:
the L2 header includes a field indicating an Ethernet type, and
the Ethernet type is one of IP Version 4 (IPv4) or IP Version 6 (IPv6).

28. The first wireless station of claim 26, wherein, to receive the message, the processing system is configured to cause the first wireless station to:
receive the message via a same basic service set or an extended service set in an L2-bridged network in accordance with the L2 header, wherein the second network is the L2-bridged network.

29. The first wireless station of claim 26, wherein, to receive the message, the processing system is configured to cause the first wireless station to:
receive the message via an L3 network in accordance with the L3 header, wherein the second network is the L3 network.

30. A method for wireless communications at a first wireless station, comprising:
generating a message to be transmitted to a second wireless station that is in a personal area network with the first wireless station, the message including a personal area network control frame and at least one network communication header associated with a second network that is different from the personal area network; and
transmitting, to the second wireless station, the message via the second network.
